(19) United States
(12) Patent Application Publication
(10) Pub. No.: US 2012/0265707 A1
(43) Pub. Date: Oct. 18, 2012

(54) Systems and Methods for Propagating Information Between Various Levels of a Construction Specification

(76) Inventor: Christopher G. Bushnell, Salt Lake City, UT (US)

(21) Appl. No.: 13/086,374

(22) Filed: Apr. 13, 2011

(51) Int. Cl. G06Q 10/00

(52) U.S. Cl. 705/342

(57) ABSTRACT

Methods for propagating information between various documents, each having differing levels of detail about a project include receiving input defining information to be included in a first document and incorporating the information at a first level of detail into the first document. Additional information is automatically generated at one or more additional levels of detail varying from the first level of detail for incorporation into one or more additional documents and is automatically and selectively incorporated into the one or more additional documents. The project may be a construction project or may be associated with a construction project, and the documents may include specification documents for the construction project. Alternatively, the project may be in any of a variety of other fields where documents are to be assembled with differing levels of detail and/or customization.

### CROSS-REFERENCE TO RELATED APPLICATIONS

This application is related to copending application Ser. No. ______, filed Apr. 13, 2011 and titled Systems and Methods for Creating and Maintaining a Customized Version of a Master Document, attorney docket no. 18189.3, which is incorporated herewith by reference for all it discloses.

### BACKGROUND OF THE INVENTION

1. Field of the Invention

The present invention relates to construction specifications, and more particularly to systems and methods that propagate modifications between various versions of a construction specification.

2. Background and Related Art

Construction specifications, along with drawings, are prepared as part of the contract documents for constructing a facility and are typically assembled into a Project Manual along with the bidding documents. The current state of the art for preparing specifications ranges from writing a specification from “scratch”, using a prewritten manufacturer's proprietary specification, using the specification from the last project, or using a commercial master specification and editing it to generate the specification. Commercial master specifications currently are provided as word processing files or as a database. Each word processing file is a separate specification section. In the database iteration, the entire specification is stored in one file. In both cases, the user edits the content of the master specification to achieve the appropriate information for the project.

Construction specifications are the culmination of a myriad of decisions that have been made throughout the project design process. In the traditional design process, some design professionals prepare preliminary project descriptions during the schematic design phase and outline specifications during the design development phase. These documents attempt to record the decisions that are made during these phases, as well as items on the drawings that affect the specifications. Until now, there has been no easy and accurate method for transferring these decisions from one phase to the next phase.

The design professional is required to determine the appropriate features, capabilities, and attributes of the products, materials, and systems that will be included in the project. Once that has been done, the design professional must include the appropriate language in the specification. There is currently no easy method to do this, as even design professionals that use a commercial master specification must read the master text and determine which of it is appropriate. Some database systems have incorporated “linkages” between master text to make this easier and more accurate, but the design professional must still review the “deleted” or “unselected” text to determine if it should be included. Additionally, much specification text is the same from section to section, which requires repetitive editing by the design professional. Some database systems use instances of common text that can be used in multiple sections.

Similar problems may be encountered in other industries.

### BRIEF SUMMARY OF THE INVENTION

Implementation of the invention provides a computer-aided method for propagating information between various specification documents associated with a project, the specification documents having differing levels of detail about the project. The method includes receiving, at a computer system, input defining information to be included in a first specification document and using the computer system to incorporate the information at a first level of detail into the first specification document. The method also includes automatically generating additional information at one or more additional levels of detail varying from the first level of detail for incorporation into one or more additional specification documents, and automatically and selectively incorporating the additional information into the one or more additional specification documents.

The specification documents may be substantially simultaneously assembled and modified such that action directed by a user with respect to one of the specification documents is automatically and substantially simultaneously taken with respect to all other specification documents associated with the project, at a level of detail appropriate for each specification document. The specification documents may be linked and may include a project life cycle description, a preliminary project description, an outline specification, a short form specification, a long form specification, a record specification, an operation and maintenance specification, and the like.

The specification documents may include collections of master text clauses drawn from a master specification. When an update is made to one or more master text clauses in the master specification, an evaluation may be conducted of each of the specification documents to determine whether the update should be made to corresponding clauses in the specification documents. Corresponding clauses in the specification documents may be updated when the corresponding clauses have not been customized. If the corresponding clauses in the specification documents have been customized, either the corresponding clauses in the specification documents are not updated or a user is notified of the update to the one or more master text clauses, and the user indicates whether to update any corresponding clauses in the specification documents. Corresponding clauses in the specification documents selected for update by the user are then selectively updated.

The specification documents may include a sub master specification that includes customized master text clauses for use with specification documents dependent on the sub master specification. In a construction setting, the master text clauses and/or customized master text clauses may include master text clauses describing administrative requirements of construction products, materials, systems, and assemblies; master text clauses describing properties and performance requirements of construction products, materials, systems, and assemblies; master text clauses describing the installation requirements of construction products, materials, systems, and assemblies; master text clauses listing the manufacturers of construction products, materials, systems, and assemblies; and master text clauses identifying the construction standards that apply to construction products, materials, systems, and assemblies.

The master text clauses included in the specification documents may be drawn from the master specification at the direction of input received from a user such as input associated with a master checklist of items relating to the master text clauses, and input received from a question-and-answer dialog relating to the master text clauses, wherein the question-and-answer dialog leads to related questions and answers based on input responses to previous answers.

In some implementations, the master text clauses are stored in a relational database system having master text clauses incorporating specific attributes for inclusion in the specification documents, master checklists summarizing attributes for inclusion in the specification documents with links to the master text clauses, master question-and-answer dialogs summarizing attributes for inclusion in the specification documents with links to the master text clauses, and master classification systems defining how the specification documents should be assembled. The relational database system may be implemented on a server and accessed by a client computer device over a network.

In some implementations, a first state of the specification documents and a second state of the specification documents may be saved and differences between the specification documents in the first state and the specification documents in the second state may be identified and compared.

Another implementation of the invention provides a non-transitory computer-readable medium storing computer-readable instructions for implementing a method for propagating information between various documents associated with a project, the documents having differing levels of detail about the project. The method includes receiving input defining information to be included in a first document and incorporating the information at a first level of detail into the first document. The method also includes automatically generating additional information at one or more additional levels of detail varying from the first level of detail for incorporation into one or more additional documents and automatically and selectively incorporating the additional information into the one or more additional documents. The project may be a construction project or may be associated with a construction project. Alternatively, the project may be in any of a variety of other fields where documents are to be assembled with differing levels of detail and/or customization.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system that may be used with embodiments of the invention;

FIG. 2 shows a representative networked computer system that may be used with embodiments of the invention;

FIG. 3 illustrates a hierarchical representation of a relationship between various illustrative construction documents; and

FIG. 4 shows a flow chart illustrating methods in accordance with embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide a computer-aided method for propagating information between various specification documents associated with a project, the specification documents having differing levels of detail about the project. The method includes receiving, at a computer system, input defining information to be included in a first specification document and using the computer system to incorporate the information at a first level of detail into the first specification document. The method also includes automatically generating additional information at one or more additional levels of detail varying from the first level of detail for incorporation into one or more additional specification documents, and automatically and selectively incorporating the additional information into the one or more additional specification documents. Information may also be propogated to or from other information sources, such as Building Information Models (BIMs), cost estimating programs, project management programs, code checking programs, analysis programs (structural, energy, etc.), and product/material ordering programs. Any propagation can occur and flow in any direction from any first document to any second document and vice-versa.

The specification documents may be substantially simultaneously assembled and modified such that action directed by a user with respect to one of the specification documents is automatically and substantially simultaneously taken with respect to all other specification documents associated with the project, at a level of detail appropriate for each specification document. The specification documents may be linked and may include a project life cycle description, a preliminary project description, an outline specification, a short form specification, a long form specification, a record specification, an operation and maintenance specification, and the like.

The specification documents may include collections of master text clauses drawn from a master specification. When an update is made to one or more master text clauses in the master specification, an evaluation may be conducted of each of the specification documents to determine whether the update should be made to corresponding clauses in the specification documents. Corresponding clauses in the specification documents may be updated when the corresponding clauses have not been customized. If the corresponding clauses in the specification documents have been customized, either the corresponding clauses in the specification documents are not updated or a user is notified of the update to the one or more master text clauses, and the user indicates whether to update any corresponding clauses in the specification documents. Corresponding clauses in the specification documents selected for update by the user are then selectively updated.

The specification documents may include a sub master specification that includes customized master text clauses for use with specification documents dependent on the sub master specification. In a construction setting, the master text clauses and/or customized master text clauses may include master text clauses describing administrative requirements of construction products, materials, systems, and assemblies; master text clauses describing properties and performance requirements of construction products, materials, systems, and assemblies; master text clauses describing the installation requirements of construction products, materials, systems, and assemblies; master text clauses listing the manufacturers of construction products, materials, systems, and assemblies; and master text clauses identifying the construction standards that apply to construction products, materials, systems, and assemblies.

The master text clauses included in the specification documents may be drawn from the master specification at the direction of input received from a user such as input associated with a master checklist of items relating to the master text clauses, and input received from a question-and-answer dialog relating to the master text clauses, wherein the question-and-answer dialog leads to related questions and answers based on input responses to previous answers.

In some embodiments, the master text clauses are stored in a relational database system having master text clauses incorporating specific attributes for inclusion in the specification documents, master checklists summarizing attributes for inclusion in the specification documents with links to the master text clauses, master question-and-answer dialogs summarizing attributes for inclusion in the specification documents with links to the master text clauses, and master classification systems defining how the specification documents should be assembled. The relational database system may be implemented on a server and accessed by a client computer device over a network.

In some embodiments, a first state of the specification documents and a second state of the specification documents may be saved and differences between the specification documents in the first state and the specification documents in the second state may be identified and compared. The user is thus alerted to differences between the document states and is provided an opportunity to resolve the difference in any desired fashion.

Other embodiments of the invention provide a non-transitory computer-readable medium storing computer-readable instructions for implementing a method for propagating information between various documents associated with a project, the documents having differing levels of detail about the project. The method includes receiving input defining information to be included in a first document and incorporating the information at a first level of detail into the first document. The method also includes automatically generating additional information at one or more additional levels of detail varying from the first level of detail for incorporation into one or more additional documents and automatically and selectively incorporating the additional information into the one or more additional documents. The project may be a construction project or may be associated with a construction project. Alternatively, the project may be in any of a variety of other fields where documents are to be assembled with differing levels of detail and/or customization.

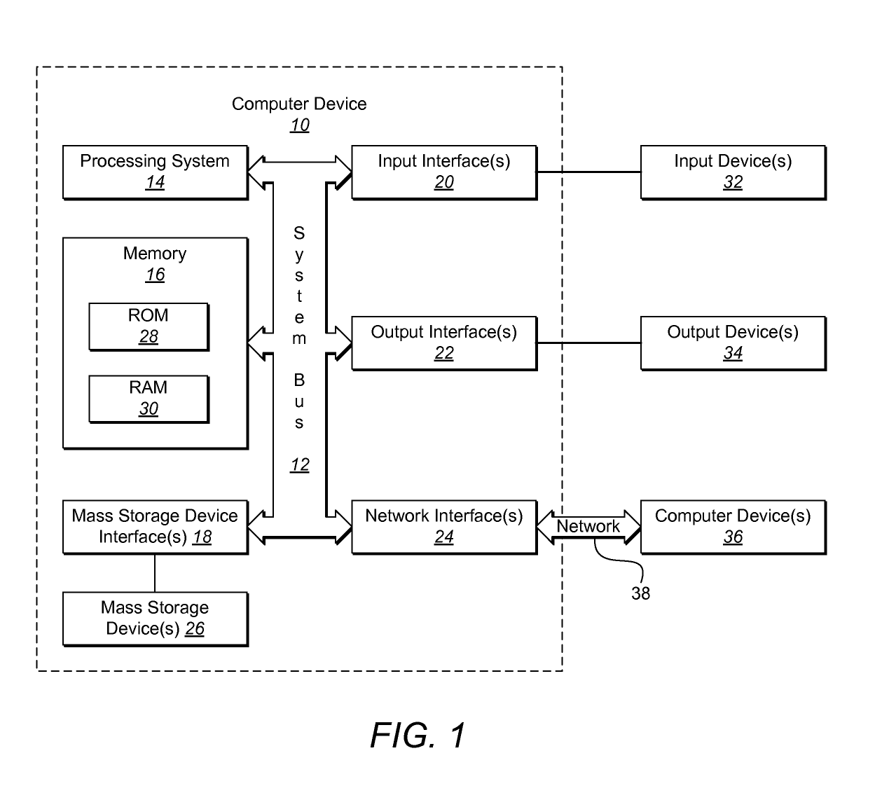

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, touchscreen, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

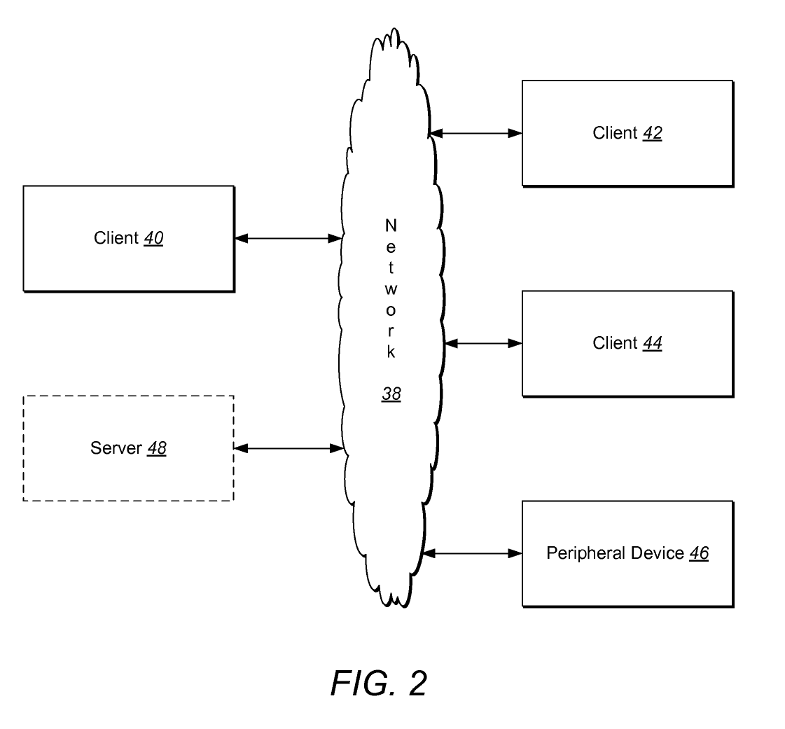

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

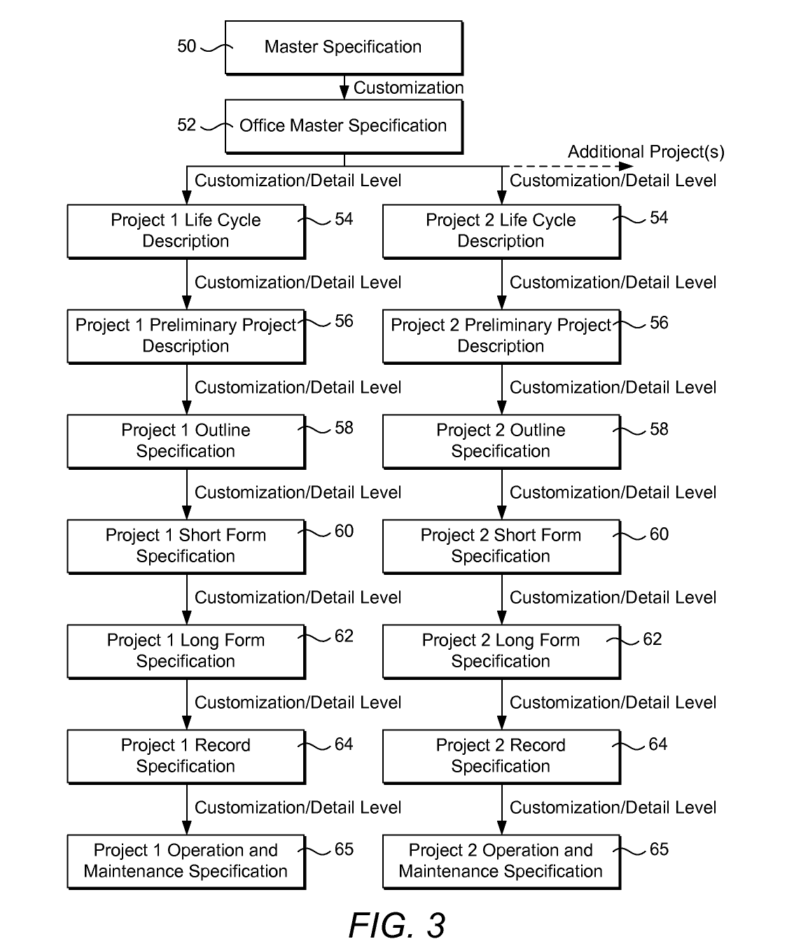

Embodiments of the invention eliminate many of the problems inherent with current specification production in the construction industry as well as similar problems in other industries. Utilizing embodiments of the invention, the design professional is able to record decisions at any phase of a project and have those decisions automatically and simultaneously create specification documents appropriate to each phase. For example, FIG. 3 illustrates various levels of specification documents that may be applicable to a particular project. The details of FIG. 3 are intended to be illustrative, and it should be understood that various embodiments may include more or fewer document levels than those illustrated in FIG. 3.

FIG. 3 illustrates a situation especially applicable to the construction industry and construction products, and it will be understood that the documents illustrated in FIG. 3 can be modified for other applicable industries and projects, where “projects” should be understood to be any desirable goal, project, or other tangible or intangible end result. For example, in the construction industry, a project may be a building, infrastructure, or other structure, facility, or some portion thereof. In the insurance industry, a project may be an insurance policy and/or a total insurance package of policies. These are merely illustrative uses of the term “project” as it relates to embodiments of the invention.

In FIG. 3, there are various specification levels illustrated in a hierarchical arrangement. FIG. 3 shows a master specification 50 and an office master specification 52. The master specification 50 may include a variety of master text clauses and may therefore be part of or include a database of master text clauses, which may be stored on a local computer system or on a remote computer system, including a server, accessed over a local or remote network, including the Internet. The office master specification 52 may be considered a sub master specification. The office master specification 52 may be customized for use by an office or group and may be customized from the master specification 50 in ways that facilitate use by the office or group. The office or group need not be located at a single physical location to utilize the office master specification 52.

The office master specification 52 may be customized, for example, by eliminating certain master text clauses as options for the office's or group's projects as being options not needed or never to be used by the office or group. For example, if a certain product, material, system, assembly, or feature is unneeded or unavailable in a certain area for whatever reason (e.g. the manufacturer does not ship to that location, the local climate dictates using other products, etc.), then any applicable master text clauses may be eliminated. As another example, if the office or group determines that it will use a certain brand or manufacturer of certain types of products, master text clauses referring to products of other brands or manufacturers may be eliminated. Customization of this type may facilitate increased efficiency of specification generation within the office or group.

Other types of customization may also be available. For example, custom master text clauses may be added to the office master specification 52 that are not available in the master specification 50. For example, if the office or group is aware of local manufacturers that are not included in the master text clauses of the master specification 50 for whatever reason (e.g. they are unknown to the entity maintaining the master specification 50), the office or group may wish to have products of the local manufacturers available for their specification documents. Thus, it may be seen that many forms of customization may occur between the master specification 50 and the office master specification 52. An office master specification 52, other sub master specification, or other sub master document is a feature that is optionally utilized with certain embodiments of the invention, and is not necessary for all embodiments.

Regardless of whether an office master specification 52 is utilized or not, a series of project-specific specification documents may be generated using embodiments of the invention. For example, as illustrated in FIG. 3, each of a first project and a second project may have the following documents associated with it: a life cycle description 54, a preliminary project description 56, an outline specification 58, a short form specification 60, a long form specification 62, a record specification 64, and an operation and maintenance specification 65. More or fewer documents may be utilized depending on the needs associated with a specific project. Additionally, while two projects are illustrated in FIG. 3, it should be understood that embodiments of the invention may be utilized with any number of projects.

As may be appreciated from the foregoing and from FIG. 3, the level of detail contained in each of the documents shown in FIG. 3 may vary from document to document. For example, the master specification 50 may include master text clauses covering a wide variety of administrative requirements, construction materials, products, systems, assemblies, installation requirements, manufacturers, construction standards, features, capabilities, attributes, industry standards, performance criteria, product designations, and the like in industry-standard language and format, but anything from a small to a large amount of this information may be irrelevant to a particular project. Similarly, the life cycle description 54 for a first project may include a level of detail significantly less detailed than is needed, for example, in the long form specification 62 for the project. Thus, each document may have a level of detail applicable to the particular needs associated with that document.

Embodiments of the invention allow propagation of changes and other information between the various levels of documents at a level of detail appropriate to each level of document. For example, if a design professional decides that a structure will have a sloped roof with asphalt shingles, the design professional may enter certain details associated with the decision in one of the documents, such as the preliminary project description 56 or the outline specification 58. The entry of the details may occur through use of a master checklist or a question-and-answer format, rather than requiring the user to read through an entire master specification to look for applicable master text clauses. The applicable master text clauses are then assembled, such as from a database, and are automatically displayed and incorporated in an industry-standard format and at an appropriate level of detail for all the document levels.

Thus, while one level of the documents might simply specify a sloped roof with asphalt shingles, another level of the documents might specify all the materials to be used in building the sloped roof with asphalt shingles. Another level of the documents might specify specific manufacturers for some or all of the materials to be used. And so on for each level of the documents. In at least some embodiments or instances, changes to a more-general level of document may not automatically generate exact details in a more-detailed level of document, but may instead provide a number of available options in the more-detailed level of document that may correspond to the changes in the more-general level of document. Alternatively, where entry of exact details in a more-detailed level of document is appropriate (e.g. such details are specified by or determinable from the master specification 50 or the office master specification 52), such exact details may be incorporated.

Changes may be propagated from a document at one level of detail to documents at any other level of detail, not just to more-detailed levels of documents. For example, an initial decision to specify a sloped roof with asphalt shingles might be made and entered into the preliminary project description 56, and accompanying changes automatically propagated to the other applicable documents. Then, at a later time, a professional working with the customer and with the long form specification 62 may determine that instead the roof should be changed to a sloped metal roof and may enter the changes to the long form specification 62. This change may be propagated both upward and downward, and would result in a change to the details of the preliminary project description 56.

In contrast, if the professional merely chooses a specific brand and color of the asphalt shingles to be used on the roof, a change such as this may not result in a change to documents at all levels of specificity or generality. For example, if this change is made to the long form specification, one or more more-general documents such as the preliminary project description 56 or the outline specification 58 may not need any change, as the specified details may still fall within the broad description contained in one or both of those documents. Thus, systems and methods in accordance with embodiments of the invention utilize sophisticated and intelligent decision making to determine to what extent a change at any level of any document in the hierarchy of documents should be propagated to other levels of documents.

Embodiments of the invention provide several mechanisms to propagate updates through the various levels of documents. For example, an entity maintaining the master specification 50 and/or an entity maintaining the office master specification 52 may determine that it is appropriate to provide an update to the master text clauses of the master specification 50 and/or the office master specification 52. For example, an update may be desirable to reflect a changing industry standard. Similarly, an update may be helpful to include new products from existing manufacturers that were not previously available or new products from new manufacturers. Indeed, there may be any number of reasons why an update is to be made to the master specification 50 and/or the office master specification 52. When an update is made to the master specification 50 and/or to the office master specification 52, an intelligent process may be used to determine to what extent the update is propagated to the other documents.

For example, in some instances, it may be necessary to incorporate the update in corresponding clauses in the other specification documents. If the update is urgent, such as it reflects a new law or construction standard that must be incorporated into the specification documents, the system may determine to update corresponding clauses incorporated into the other specification documents (e.g. the update is propagated). In other instances, a more-nuanced analysis may be undertaken. For example, if the corresponding clauses in one or more of the other specification documents has been customized by the user (e.g. for the project or for the office master specification 52), it may not be desirable to automatically propagate the update at the expense of the customization. Instead, one of several actions may be taken.

In a first instance, the system may simply determine that the customization takes precedence over the proposed update and that the update will not be propagated into the other specification documents containing the customization. In another alternative, a notice is provided to the user that an update to the master text clauses has occurred and that one or more corresponding clauses in the other specification documents can be updated accordingly. The notice may indicate to the user what the update is and what clauses of the other specification documents will be affected. The notice may also indicate to the user how the clauses of the other specification documents will be affected. An indication is then received from the user as to whether to update any corresponding clauses in any specification documents selected for update by the user. Additionally, the user may also select to update the clauses with or without further customization of the updated clauses in at least some embodiments.

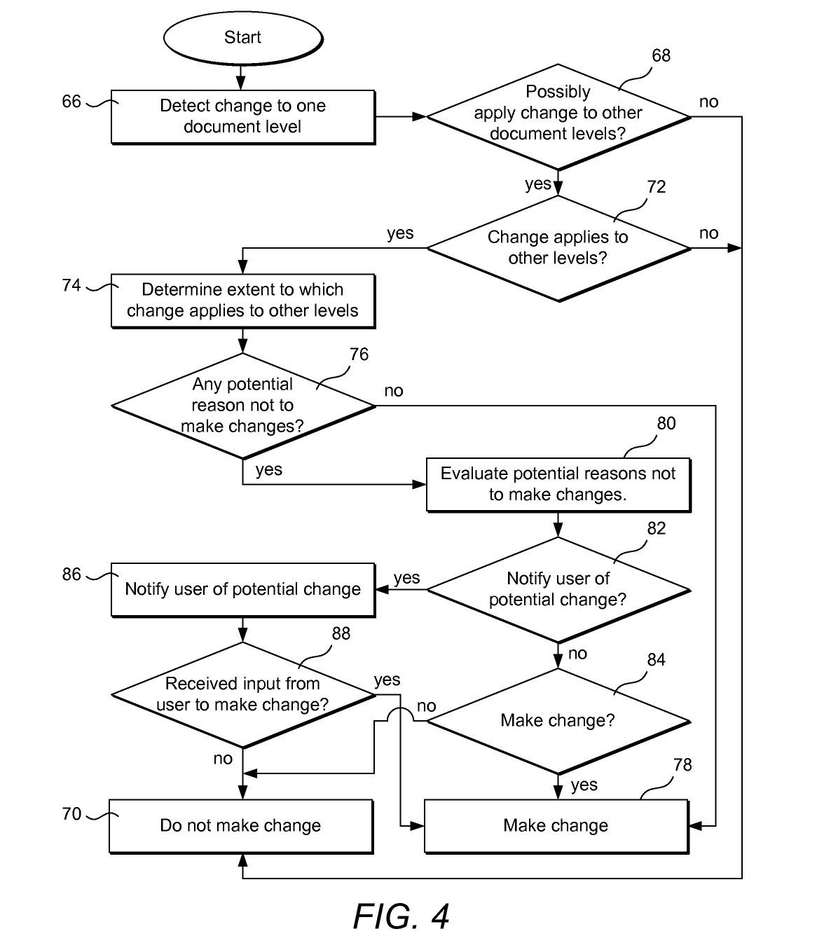

FIG. 4 illustrates aspects of methods that can be utilized to propagate changes between various levels of documents. As the methods may be varied from situation to situation, the specifics illustrated in FIG. 4 are intended to be illustrative only. Execution begins at step 66, where a change is detected in a document at one level of specificity. The change may occur at any level, and for the example of FIG. 3 may include changes (e.g. updates) to the master specification 50, changes (e.g. office customizations) to the office master specification 52, and changes (e.g. defining aspects of a project) at any level of a specific project's documents. The foregoing are merely examples of possible changes that could be made and detected.

After the change is detected, the system makes a determination as at decision block 68 as to whether the change should possibly be applied to other document levels. If, for example, the change is a customization to the office master specification 52 and there are no associated projects dependent on the office master specification 52, there may be no need to make any changes to any other documents. Similarly, if the change is made in the most-detailed level of document and does not affect any more-general selections in the more-general levels of documents, there may be no need to modify any other documents levels. If there is no possibility that the change should be applied to another document, execution proceeds to step 70, and no further change is made.

If, however, there is a possibility that a change should be propagated to other document levels, execution proceeds to decision block 72, where a determination is made as to whether the change actually is applicable to other levels of document. While a change could potentially be applicable to other levels of documents, other considerations may intervene to make a change irrelevant. For example, if an update is made to the master specification 50 of FIG. 3 relating to adequate roof construction for high snow load environments, the change may be simply inapplicable to a customized office master specification 52 of a design firm in Phoenix, Ariz. The design firm may have modified its office master specification 52 to eliminate reference to snow load conditions as such conditions are not encountered by buildings in the design firm's location. Since there is no corresponding clause in the office master specification 52 in this instance, there would be no need to apply the change to other levels of document, and the process would proceed to step 70 and no further changes would be made.

Alternatively, if the potential change applies to other levels of documents, execution proceeds to step 74, where a determination is made as to an extent to which any changes apply to other document levels. Thus, if the change is made to a more-detailed document and has no effect on less-detailed documents and only affects other more-detailed documents, the change may only be considered for the more-detailed documents. Similarly, if the change affects both more-detailed and more-general levels of documents, it may be considered for all applicable documents. At decision block 76, a determination is made as to whether there are any potential reasons not to make a change in a particular document level. Any reasons may vary, such as the existence of a customization balancing against a potential update. If no reasons not to make a change exist, execution proceeds to step 78, where a change is made in one or more levels of documents. Of course, it should be understood that changes can be made in some levels of documents and not others.

As discussed above, there may be potential reasons not to make a change to a particular document. For example, the document may include a customization that could be affected if the change were made. Thus, if there are potential reasons not to make a change, execution proceeds to step 80 where an evaluation is made of the potential reason or reasons not to make a change. Execution then proceeds to decision block 82 where a determination is made whether to notify the user of a potential change to allow the user to accept or reject the change. If, at step 80, the potential reason or reasons not to make the change were evaluated and it was determined that the change simply should not be made, or if it was determined that the change should be made regardless of any input that might be provided by the user, execution proceeds to decision block 84, where a determination is made whether to make the change and then execution proceeds to one of steps 70 and 78 accordingly.

If, however, a determination is made to notify the user of a potential change and to allow the user to provide input as to whether to make a change, execution proceeds to step 86, and the user is notified of the potential change. As discussed above, the notification may include information explaining what document or documents is proposed to be changed, what changes are proposed, how the document currently exists and how it would exist if modified, and the like. The user is then able to provide an input as to whether to make the change or not, and execution proceeds to decision block 88 where a determination is made as to whether an input was received from the user to make the proposed change. If yes, execution proceeds to step 78 and the change is made (which may include further changes or customizations from the user, if desired). If no input from the user is received indicating to make the change, execution proceeds to step 70 and no change is made. In some embodiments, whether to make the change defaults to not making the change if no input is received from the user. In other instances, the default action or response may vary for any of a variety of reasons, including the scope of the proposed change.

As may be appreciated from the discussion herein, changes may be made by various individuals associated with a project at different stages of the project. In many instances, it may be desirable to keep track of changes made by different persons. For example, many initial decisions affecting a project may be made during a design phase that might be primarily entered into the preliminary project description. At a later date, as additional details about a project are being made, an architect or other design professional fleshing out the long form specification 62 might encounter a problem necessitating changes that affect multiple document levels. If changes are tracked, the changes entered by the architect or other design professional could be reviewed by whoever made the initial decisions or by anyone else associated with the project to ensure that the changes comport with what is desired for the project.

Thus, at least some embodiments of the invention allow documents associated with a project to be archived or saved at any desirable point in time during the process where the documents are in use. Multiple different states of the documents may be saved, and comparisons may be made between different saved and/or current states to identify differences between the different states. Any changes that exist between the different states may thus be identified, and the users responsible for any identified changes may also be identified or recorded. Information relating to the identified changes may be presented in any of a variety of ways, such as by a report that may be displayed visually on a computer monitor, saved, printed, shown on a tab within a computer software program, etc. In ways such as this, embodiments of the invention facilitate comparisons of decisions about projects and allow design professionals to communicate more effectively with their clients about the progress of decisions about the projects.

Additionally, not every change that is made in a document can be readily or easily propagated to every other level of document where a change might need to be made. For example, where a customization is made in a document, the system might not have applicable master text clauses available for every level of detail that correspond to the customization. Therefore, embodiments of the invention may recognize situations where changes are potentially applicable to other documents at different levels of detail and where the system lacks sufficient information to determine what changes need to be made. Therefore, the system provides a flag or other warning to the user or users (which may be included in any change reports as discussed previously) indicative of the need for input from one or more users to provide customized changes to the various document levels. As the flag or other warning is responded to and changes are entered to the various document levels, embodiments of the invention may utilize learning methods to incorporate the various changes and customizations being made, such as into the office master specification 52, for use in other projects with similar customizations. If desired, a prompt may be made to request the user's approval to incorporate the customizations into the office master specification 52 for future use.

As may be appreciated from the foregoing description, various levels of documents may be linked together as needed within a project. The documents may also be assembled and/or stored together. The linking, assembly, and storage of documents may occur using any methods, systems, and computer languages now known or later invented. By way of example, structured text as described in U.S. Pat. No. 5,341,469, which is incorporated herein by reference for all it discloses, may be used in assemblage, storage, and linkage of various documents, as can extensible markup language (XML), Industry Foundation Classes XML (ifcXML), and hyperlinks, as applicable. The foregoing should be understood as merely being examples that can be used with or by embodiments of the invention.

Embodiments of the invention may be used in essentially any field of use where creation or assembly of documents is desired using master text clauses. Embodiments of the invention are especially helpful for use in instances where documents of varying levels of detail are desired. Thus, as discussed herein, embodiments of the invention are particularly useful in the area of construction specification generation. In such embodiments, the master text clauses may include (1) clauses describing administrative requirements of construction products, materials, systems, and assemblies, (2) clauses describing the characteristics of construction products, materials, systems, and assemblies, (3) clauses describing the installation requirements of construction products, materials, systems, and assemblies, (4) clauses listing the manufacturers of construction products, materials, systems, and assemblies, (5) clauses including the construction standards that apply to the construction products, materials, systems, and assemblies, and (6) clauses incorporating a specific feature, capability, and/or attribute to be included in a specification document, which may (a) describe physical, functional, and performance characteristics of the construction products, materials, systems, and assemblies, (b) be specified using descriptions, reference to industry standards, performance criteria, and/or product designations, and (c) be written in industry-standard language and format. Of course, the foregoing list is intended to be merely illustrative of an exemplary scope of a set of master text clauses applicable to one field of use of embodiments of the invention.

As another example of a potential field of use, embodiments of the invention may be utilized to assemble an insurance policy from a database of insurance policy clauses (e.g. master text clauses). The assembly of the insurance policy may occur using a master checklist of coverages, exclusions, and endorsements selected by the user (e.g. an insurance professional). In such an embodiment, the master text clauses may include any possibly-applicable insurance policy clauses, governing regulations, and the like in industry-standard language. The foregoing is merely one example of an alternate field of use for embodiments of the invention. Embodiments of the invention may be utilized in any other desirable field of use.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A computer-aided method for propagating information between various specification documents associated with a project, the specification documents having differing levels of detail about the project, the method comprising:
receiving, at a computer system, input defining information to be included in a first specification document;
using the computer system to incorporate the information at a first level of detail into the first specification document;
automatically generating additional information at one or more additional levels of detail varying from the first level of detail for incorporation into one or more additional specification documents; and
automatically and selectively incorporating the additional information into the one or more additional specification documents.

2. A method as recited in claim 1, wherein the specification documents are substantially simultaneously assembled and modified such that action directed by a user with respect to one of the specification documents is automatically and substantially simultaneously taken with respect to all other specification documents associated with the project, at a level of detail appropriate for each specification document.

3. A method as recited in claim 1, wherein the specification documents are linked and comprise specification documents selected from the group of:
a project life cycle description;
a preliminary project description;
an outline specification;
a short form specification;
a long form specification;
a record specification; and
an operation and maintenance specification.

4. A method as recited in claim 1, wherein the specification documents comprise collections of master text clauses drawn from a master specification.

5. A method as recited in claim 4, wherein when an update is made to one or more master text clauses in the master specification, the computer system conducts an evaluation of each of the specification documents and determines whether the update should be made to corresponding clauses in the specification documents.

6. A method as recited in claim 5, wherein the computer system determines to update corresponding clauses in the specification documents when the corresponding clauses have not been customized.

7. A method as recited in claim 5, wherein the computer system determines that the corresponding clauses in the specification documents have been customized and takes an action selected from the group of:
determining not to update the corresponding clauses in the specification documents; and
notifying a user of the update to the one or more master text clauses, receiving an indication from the user as to whether to update any corresponding clauses in the specification documents, and selectively updating any corresponding clauses in the specification documents selected for update by the user.

8. A method as recited in claim 7, wherein the specification documents include a sub master specification comprising customized master text clauses for use with specification documents dependent on the sub master specification.

9. A method as recited in claim 4, wherein the master text clauses comprise at least one of:
master text clauses describing administrative requirements of construction products, materials, systems, and assemblies;
master text clauses describing properties and performance requirements of construction products, materials, systems, and assemblies;
master text clauses describing the installation requirements of construction products, materials, systems, and assemblies;
master text clauses listing the manufacturers of construction products, materials, systems, and assemblies; and
master text clauses identifying the construction standards that apply to construction products, materials, systems, and assemblies.

10. A method as recited in claim 4, wherein the master text clauses included in the specification documents are drawn from the master specification at the direction of input received from a user selected from the group consisting of:
input associated with a master checklist of items relating to the master text clauses;
input received from an outside source selected from the group of a building information model (BIM), a cost estimating program, a project management program, and an analysis program;
input received from a question-and-answer dialog relating to the master text clauses, wherein the question-and-answer dialog leads to related questions and answers based on input responses to previous answers.

11. A method as recited in claim 4, wherein the master text clauses are stored in a relational database system comprising:
master text clauses incorporating specific attributes for inclusion in the specification documents;
master checklists summarizing attributes for inclusion in the specification documents with links to the master text clauses;
master question-and-answer dialogs summarizing attributes for inclusion in the specification documents with links to the master text clauses; and
master classification systems defining how the specification documents should be assembled.

12. A method as recited in claim 11, wherein the relational database system is contained on a server and accessed by a client computer device over a network or the Internet.

13. A method as recited in claim 1, further comprising:
saving a first state of the specification documents;
saving a second state of the specification documents; and
identifying and comparing differences between the specification documents in the first state and the specification documents in the second state.

14. A non-transitory computer-readable medium storing computer-readable instructions for implementing a method for propagating information between various documents associated with a project, the documents having differing levels of detail about the project, the method comprising:
receiving input defining information to be included in a first document;
incorporating the information at a first level of detail into the first document;
automatically generating additional information at one or more additional levels of detail varying from the first level of detail for incorporation into one or more additional documents; and
automatically and selectively incorporating the additional information into the one or more additional documents.

15. A non-transitory computer-readable medium as recited in claim 14, wherein the documents are substantially simultaneously assembled and modified such that action directed by a user with respect to any one of the specification documents is automatically and substantially simultaneously taken with respect to all other specification documents associated with the project, at a level of detail appropriate for each specification document.

16. A non-transitory computer-readable medium as recited in claim 14, wherein the documents comprise collections of master text clauses drawn from a master document.

17. A non-transitory computer-readable medium as recited in claim 16, wherein when an update is made to one or more master text clauses in the master document, the method further comprises:
conducting an evaluation of each of the other documents; and
determining whether the update should be made to corresponding clauses in the other documents.

18. A non-transitory computer-readable medium as recited in claim 17, further comprising determining to update corresponding clauses in the other documents when the corresponding clauses have not been customized.

19. A non-transitory computer-readable medium as recited in claim 17, further comprising determining that the corresponding clauses in the other documents have been customized and taking an action selected from the group of:
determining not to update the corresponding clauses in the other documents; and
notifying a user of the update to the one or more master text clauses, receiving an indication from the user as to whether to update any corresponding clauses in the other documents, and selectively updating any corresponding clauses in the other documents selected for update by the user.

20. A non-transitory computer-readable medium as recited in claim 14, wherein the project is a construction project and the documents comprise specification documents for the construction project.
